(19) United States
(12) Patent Application Publication
(10) Pub. No.: US 2021/0146662 A1
(43) Pub. Date: May 20, 2021

(54) LAYERED PRODUCT AND METHOD FOR PRODUCING SAME

(71) Applicant: OSAKA UNIVERSITY, Osaka (JP)

(72) Inventors: Yuji OHKUBO, Osaka (JP); Kazuya YAMAMURA, Osaka (JP); Kento ISHIHARA, Osaka (JP); Masafumi SHIBAHARA, Hyogo (JP); Asahiro NAGATANI, Hyogo (JP); Koji HONDA, Hyogo (JP)

(73) Assignee: OSAKA UNIVERSITY, Osaka (JP)

(21) Appl. No.: 16/617,091

(22) PCT Filed: May 31, 2018
(86) PCT No.: PCT/JP2018/020991

§ 371 Date: Nov. 26, 2019

(30) Foreign Application Priority Data
May 31, 2017 (JP) 2017-108427

(51) Int. Cl. B32B 25/08; C08K 3/36; B32B 27/32; B32B 25/12; B32B 25/18; B32B 37/06; B32B 37/10; B32B 25/02; B32B 38/00

(52) U.S. Cl. CPC B32B 25/08; C08K 3/36; B32B 27/322; B32B 25/12; B32B 25/18; B32B 2310/14; B32B 37/10; B32B 25/02; B32B 38/0008; B32B 2307/538; B32B 2264/1021; B32B 37/06

(57) ABSTRACT

An object of the present invention is to provide a layered product of a polymer layer made of PTFE or the like and the rubber, with further improvement in the adhesiveness between the polymer layer and the rubber layer. A layered product in which a fluorine-containing polymer compound layer and a rubber layer formed from a rubber composition are stacked, wherein the fluorine-containing polymer compound is polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit, and the rubber layer contains SiO₂.

### TECHNICAL FIELD

The present invention relates to a layered product in which a fluorine-containing polymer compound layer and a rubber layer are stacked, and a method for producing the same.

### BACKGROUND ART

Conventionally, etching treatment, ultraviolet treatment, chemical vapor deposition treatment, plasma treatment, and the like have been performed in order to impart various kinds of functions to the surfaces of molded articles that contain organic polymer compounds. For example, since the surface of a molded article molded from fluororesin has low wettability and is difficult to be adhered using an adhesive, etching treatment or plasma treatment is performed as a treatment to improve the adhesiveness of the surface of the molded article.

Patent Literature 1 for which an application was filed by the present inventors, discloses a surface-modified molded article producing method characterized in causing the temperature of the surface of a molded article containing an organic polymer compound to be (the melting point of the organic polymer compound −120° C.) or higher, and subjecting the surface of the molded article to atmospheric-pressure plasma treatment, thereby introducing peroxide radicals into the surface. In Patent Literature 1, the following description is given especially regarding PTFE (polytetrafluoroethylene) which is difficult to be adhered to another material, among fluororesins. That is, if a surface of a PTFE sheet is subjected to the plasma treatment, an adhesive effect is obtained to some extent, and meanwhile, when a peel test is performed on a complex obtained by subjecting the surface of the PTFE sheet to the plasma treatment and joining the PTFE sheet to an adherend, the PTFE sheet sometimes easily peels because the surface strength of the sheet-like PTFE molded article (PTFE sheet) is low owing to influence of cutting processing at the time of molding. However, with the method disclosed in Patent Literature 1, peroxide radicals can be sufficiently formed in the surface of the molded article, and, when bonds each formed between a carbon atom and a carbon atom or an atom other than carbon atoms are broken in an organic polymer compound, crosslinking reactions occur between the carbon atoms whose bonds are broken in the macromolecules, thereby enabling improvement in the strength of the surface.

### CITATION LIST

### Patent Literature

[PTL 1] Japanese Laid-Open Patent Publication No. 2016-056363

### SUMMARY OF THE INVENTION

### Problems to be Solved by the Invention

The atmospheric-pressure plasma treatment disclosed in Patent Literature 1 enables improvement in the strength of a surface of a tetrafluoroethylene unit-containing polymer layer made of PTFE or the like and enables improvement in the adhesiveness between the polymer layer and an adherend. The present invention is particularly directed to a case where rubber is used as the adherend, and an object of the present invention is to provide a layered product of a polymer layer made of PTFE or the like and the rubber, with further improvement in the adhesiveness between the polymer layer and the rubber layer.

### Solution to the Problems

The present invention attaining the above-described object is as follows.

(1) A layered product in which a fluorine-containing polymer compound layer and a rubber layer formed from a rubber composition are stacked, wherein a surface roughness Ra of the fluorine-containing polymer compound layer is 1 μm or lower, the fluorine-containing polymer compound is polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit, an amount of an organic peroxide contained per 100 parts by mass of the rubber composition is smaller than 0.1 parts by mass, and the rubber layer contains SiO₂.

(2) The layered product according to the above (1), wherein the rubber composition is a natural rubber composition and/or a butyl-based rubber.

(3) A layered product, wherein a fluorine-containing polymer compound layer and a rubber layer formed from a natural rubber composition are stacked, an adhesive strength between the fluorine-containing polymer compound layer and the rubber layer is 0.15 N/mm or greater, a surface roughness Ra of the fluorine-containing polymer compound layer is 1 μm or lower, and the fluorine-containing polymer compound is polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit.

(4) The layered product according to any one of the above (1) to (3), wherein the adhesive strength between the fluorine-containing polymer compound layer and the rubber layer is greater than a strength of the rubber layer.

(5) The layered product according to any one of the above (1) to (4), wherein the rubber composition contains a rubber base material and SiO₂, and a proportion of SiO₂ per 100 parts by mass of the rubber base material is 10 parts by mass or higher.

(6) The layered product according to any one of above (1) to (5), wherein oxygen atoms are bonded to carbon atoms in a surface, of the fluorine-containing polymer compound layer, that faces the rubber layer.

(7) A method for producing a layered product in which a fluorine-containing polymer compound layer and a rubber layer are stacked, the fluorine-containing polymer compound being polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit, the method comprising the steps of: producing an unvulcanized rubber sheet from a natural rubber composition that contains SiO₂, causing a temperature of a surface of a molded article formed from the fluorine-containing polymer compound to be (a melting point of the polymer compound −120° C.) or higher and subjecting the surface of the molded article to atmospheric-pressure plasma treatment, to produce a surface-modified molded article, and bringing the modified surface of the surface-modified molded article and the unvulcanized rubber sheet into contact with each other, and heating and applying pressure to the surface-modified molded article and the unvulcanized rubber sheet.

### Effect of the Invention

In the present invention, the rubber layer serving as the adherend contains SiO₂, and thus it is possible to provide a layered product having an improved adhesive strength between the polymer layer made of PTFE or the like and the rubber layer without using any adhesive.

### BRIEF DESCRIPTION OF THE DRAWINGS

FIG. 1 is a schematic diagram of an atmospheric-pressure plasma treatment apparatus.

FIG. 2 is an XPS chart obtained as a result of measurement in EXAMPLES.

### DESCRIPTION OF EMBODIMENTS

The present invention is a layered product in which a fluorine-containing polymer compound layer made of polytetrafluoroethylene or the like and a rubber layer formed from a rubber composition are stacked, wherein the rubber layer contains SiO₂. Since the rubber layer contains SiO₂, an adhesive strength at the interface between the fluorine-containing polymer compound layer and the rubber layer can be improved.

In production of the layered product according to the present invention, a surface of the fluorine-containing polymer compound layer is subjected to the atmospheric-pressure plasma treatment disclosed in Patent Literature 1 such that the surface is modified. The mechanism by which the rubber layer containing SiO₂ allows the PTFE layer and the rubber layer to be adhered (joined) to each other and enables favorable adhesive strength (joining strength) to be obtained, has not been fully clarified, and conceivable mechanisms include the following one. A C—OH group or a COOH group (carboxyl group) formed by peroxide radicals introduced into a PTFE surface as a result of the atmospheric-pressure plasma treatment, and a silanol (Si—OH) group that is present in a SiO₂ surface, are bonded to each other by hydrogen bonding, or chemically bonded to each other as a result of a dehydration condensation reaction. Although the SiO₂ may be a silica obtained by wet process or a silica obtained by dry process, a hydrophilic silica is preferable. It is noted that the mechanism for the improvement of the adhesive strength in the present invention is not limited to the above-described mechanism.

The adhesive strength at the interface between the predetermined fluorine-containing polymer compound layer and the rubber layer can be specifically set to the adhesive strength of 0.15 N/mm or greater, and it is a prominent effect that the aforementioned adhesive strength has been obtained especially in a case where the rubber layer is formed from a natural rubber composition. The adhesive strength at the interface between the fluorine-containing polymer compound layer and the rubber layer is preferably 0.2 N/mm or greater and more preferably 0.3 N/mm or greater. The adhesive strength is preferably greater than the strength of the rubber layer. In other words, when a peel test at the interface between the PTFE layer and the rubber layer is performed, break preferably occurs not at the interface but at the rubber layer first. The adhesive strength in this case varies depending on the strength of the rubber layer, that is, the composition of the rubber layer, and thus cannot be unconditionally specified, and, in a case where the rubber layer is formed from a natural rubber composition, the adhesive strength is, for example, 1.5 N/mm or greater.

The amount of SiO₂ per 100 parts by mass of a rubber base material that forms the rubber layer, is preferably 10 parts by mass or larger, more preferably 12 parts by mass or larger, further preferably 15 parts by mass or larger, and particularly preferably 20 parts by mass or larger. The upper limit of the amount of SiO₂ is not particularly limited, and is, for example, 40 parts by mass or lower.

The rubber layer is preferably a rubber layer that is formed from a rubber composition of a butyl-based rubber, isoprene rubber, butadiene rubber, styrene-butadiene rubber, natural rubber (containing a polyisoprene as a main component), chloroprene rubber, a nitrile-based rubber such as acrylonitrile-butadiene rubber, a hydrogenated nitrile-based rubber, norbornene rubber, ethylene-propylene rubber, ethylene-propylene-diene rubber, acrylic rubber, ethylene-acrylate rubber, fluororubber, chlorosulfonated polyethylene rubber, epichlorohydrin rubber, silicone rubber, urethane rubber, polysulfide rubber, phosphazene rubber, 1,2-polybutadiene, or the like. These rubbers may be used singly, or two or more of these rubbers may be used in combination. Among these rubbers, a butyl-based rubber or natural rubber is preferable. Examples of the butyl-based rubber include isobutylene-isoprene copolymer rubber, halogenated isobutylene-isoprene copolymer rubber (in particular, chlorinated isobutylene-isoprene copolymer rubber (hereinafter, referred to as chlorinated butyl rubber)), and modified products thereof. In particular, the rubber layer is preferably formed from a natural rubber composition and/or a butyl-based rubber and more preferably formed from a natural rubber composition. In addition, from the viewpoint of joining to the above-described surface-modified molded article, the rubber layer preferably has a reactive functional group such as a halogen group or a thiol group derived from, for example, a crosslinking agent or a polymer as the base material of the rubber.

In general, a rubber composition that forms a rubber layer contains a crosslinking agent according to the type of a polymer as a base material of the rubber. The crosslinking agent preferably reacts with peroxide radicals introduced as a result of surface modification of the fluorine-containing polymer compound layer. Examples of the crosslinking agent include: sulfur-based crosslinking agents such as sulfur, sulfur chloride, sulfur dichloride, disulfide compounds, and polysulfide compounds; peroxide-based crosslinking agents such as dicumyl peroxide; quinoid-based crosslinking agents such as p-quinone dioxime and p,p′-dibenzoyl quinone dioxime; resin-based crosslinking agents such as low-molecular-weight alkylphenol resins; amine-based crosslinking agents such as diamine compounds (such as hexamethylene diamine carbamates); triazine thiol-based crosslinking agents such as 2-di-n-butylamino-4,6-dimercapto-s-triazine; polyol-based crosslinking agents; and metallic oxide-based crosslinking agents. From the viewpoint of improving the strength of joining to the surface-modified molded article, in a case of a butyl-based rubber, a triazine thiol-based crosslinking agent is preferably used, and, in a case of natural rubber, a sulfur-based crosslinking agent or a peroxide-based crosslinking agent is preferably used. These crosslinking agents may be used singly, or two or more of these crosslinking agents may be used in combination. In a case where the rubber layer is made of natural rubber, the amount of the triazine thiol-based crosslinking agent is preferably small. Specifically, the amount of the triazine thiol-based crosslinking agent per 100 parts by mass of the base material of the natural rubber is preferably 7 parts by mass or smaller and more preferably 3 parts by mass or smaller, and most preferably, no triazine thiol-based crosslinking agent is contained. In the case where the rubber layer is made of natural rubber, the rubber layer is particularly preferably as follows: a sulfur-based crosslinking agent and/or a peroxide-based crosslinking agent is used as the crosslinking agent, the amount of SiO₂ per 100 parts by mass of the rubber base material is 10 parts by mass or larger (more preferably 12 parts by mass or larger, further preferably 15 parts by mass or larger, and particularly preferably 20 parts by mass or larger), and no triazine thiol-based crosslinking agent is contained.

The total amount of the crosslinking agents per 100 parts by mass of the rubber base material is preferably 1 part by mass or larger, more preferably 1.5 parts by mass or larger, and further preferably 2 parts by mass or larger. Meanwhile, the total amount is preferably 10 parts by mass or smaller, more preferably 7 parts by mass or smaller, and further preferably 5 parts by mass or smaller.

The rubber composition may contain, as necessary, other additives that are blended in ordinary rubber compositions, such as a vulcanization accelerator, a crosslinking activator, a reinforcing agent, an acid acceptor, a plasticizer, a heat resistant agent, and a colorant. The total amount of the other additives contained per 100 parts by mass of the rubber base material is preferably 10 parts by mass or smaller, more preferably 8 parts by mass or smaller, and further preferably 7 parts by mass or smaller.

In the present invention, the rubber composition preferably contains substantially no organic peroxide. Specifically, the amount of an organic peroxide contained per 100 parts by mass of the rubber composition is preferably smaller than 0.1 parts by mass, more preferably 0.05 parts by mass or smaller, and further preferably 0.01 parts by mass or smaller.

The fluorine-containing polymer compound is polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit. The fluorine-containing polymer compound is preferably polytetrafluoroethylene or a copolymer of a tetrafluoroethylene unit and a hexafluoropropylene unit, a perfluoroalkyl vinyl ether unit, an ethylene unit, or a perfluorothoxole unit. Examples of the fluorine-containing polymer compound include: polyvinylidene fluoride (PVDF, melting point: 151 to 178° C.), tetrafluoroethylene-hexafluoropropylene copolymer (FEP, melting point: 250 to 275° C.), tetrafluoroethylene-perfluoroalkyl vinyl ether copolymer (PFA, melting point: 302 to 310° C.), tetrafluoroethylene-ethylene copolymer (ETFE, melting point: 218 to 270° C.), tetrafluoroethylene-perfluorodioxole copolymer (TFE-PDD), and polytetrafluoroethylene (PTFE, melting point: 327° C.). The fluorine-containing polymer compound is most preferably polytetrafluoroethylene.

In the present invention, there is no need to roughen the surface of the fluorine-containing polymer compound layer with use of sandpaper or the like, and the surface roughness Ra of the fluorine-containing polymer compound layer is preferably 1 μm or lower, more preferably 0.5 μm or lower, and further preferably 0.3 μm or lower. The surface roughness Ra can be obtained by measurement that conforms to JIS B 0601, and the surface roughness Ra of each of layered products in “EXAMPLES” described later is 0.3 μm or lower.

In addition, in the present invention, there is also no need to immerse the fluorine-containing polymer compound layer in a Na-containing chemical agent to chemically etch the surface of the fluorine-containing polymer compound layer. Whether or not the surface has been chemically etched, can be determined by slicing a portion, of the rubber layer, that faces the interface between the fluorine-containing polymer compound layer and the rubber layer so as to obtain a piece having a thickness of 0.1 mm or smaller, dissolving the piece in a solvent to obtain a solution, and performing measurement on the solution with use of an inductively coupled plasma-atomic emission spectrometer (ICP-AES) or an inductively coupled plasma-mass spectrometer (ICP-MS) to obtain a Na content. If the Na content is found to be 0.01% or smaller as a result of the above-described measurement, it can be said that the surface has not been chemically etched.

The layered product according to the present invention encompasses, as a matter of course, a layered product composed only of a single fluorine-containing polymer compound layer and a single rubber layer, and also encompasses a layered product in which other layers (including a fluorine-containing polymer compound layer and a rubber layer) are further stacked on the layered product composed only of the single fluorine-containing polymer compound layer and the single rubber layer.

Hereinafter, a method for producing the layered product according to the present invention will be described.

1. Step of Producing Unvulcanized Rubber Sheet An unvulcanized rubber sheet is produced by kneading a polymer as the base material of the rubber, a crosslinking agent, SiO₂, and additives that are used as necessary such as a crosslinking activator and a reinforcing agent, using a rubber roll machine or the like.

2. Step of Modifying Surface of Molded Article Formed from Fluorine-Containing Polymer Compound

A surface of the molded article that contains the fluorine-containing polymer compound is subjected to atmospheric-pressure plasma treatment at a surface temperature of (the melting point of the organic polymer compound −120° C.) or higher, thereby modifying the surface of the molded article. By the atmospheric-pressure plasma treatment, peroxide radicals can be introduced into the surface of the molded article, and the hardness of the surface can be increased.

When the atmospheric-pressure plasma treatment is performed, the surface temperature of the molded article is caused to be (the melting point of the polymer compound contained in the molded article (hereinafter, sometimes referred to simply as melting point) −120° C.) or higher. By causing the surface temperature to be such a temperature, the mobility of macromolecules of the polymer compound in the surface of the molded article to be subjected to plasma irradiation, is heightened. If such a polymer compound with heightened mobility is irradiated with plasma, when bonds each formed between a carbon atom and a carbon atom or an atom other than carbon atoms are broken in the polymer compound, crosslinking reactions occur between the carbon atoms whose bonds are broken in the macromolecules, thereby enabling improvement in the strength of the surface, while peroxide radicals can be sufficiently formed. The surface temperature of the molded article is more preferably (melting point −100° C.) or higher and further preferably (melting point −80° C.) or higher. The surface temperature of the molded article is preferably caused to be within the aforementioned range especially in a case where the organic polymer compound which forms the molded article is PTFE. The surface temperature of the molded article is preferably 20° C. or higher in addition to satisfying requirement of being (melting point −120° C.) or higher. The upper limit of the surface temperature of the molded article is not particularly limited, and may be caused to be, for example, (melting point+20° C.) or lower.

The configuration of a molded article to be used in the present invention is not particularly limited as long as the molded article is in a form to which plasma can irradiate, and those having various kinds of forms and structures may be employed. Examples of the form may include square form, spherical form, thin film form and the like having a surface shape such as a flat surface, a curved surface, or a bent surface, but not limited to these forms. Further, the molded article may be one formed by any of various kinds of molding methods such as injection molding, melt extrusion molding, paste extrusion molding, compression molding, cutting molding, cast molding, and impregnation molding, depending on the characteristics of a polymer compound. Still further, the molded article may have a dense and continuous structure of the resin as in, for example, a common injection molded article, may have a porous structure, may be in the form of a nonwoven fabric, or may have another structure.

In the present invention, the surface of a molded article containing a polymer compound is modified by atmospheric-pressure plasma. The conditions of the treatment by atmospheric-pressure plasma are not particularly limited as long as peroxide radicals can be introduced into the surface of the molded article. The conditions which can be employed in technical fields for modifying the surface of a molded article by plasma and which are capable of generating atmospheric-pressure plasma may be employed properly. Naturally, in the present invention, in order to carry out the treatment by atmospheric-pressure plasma with the surface temperature of the molded article being adjusted to be in a predetermined temperature range capable of heightening the mobility of macromolecules of the organic polymer compound in the surface of the molded article, the atmospheric-pressure plasma treatment is preferably performed under conditions by which a heating effect is obtained in the case where the surface temperature is raised only by the heating effect of the atmospheric-pressure plasma treatment.

Atmospheric-pressure plasma may be generated using, for example, a high frequency electric power source with a frequency of applied voltage in a range of 50 Hz to 2.45 GHz. Further, the output power per unit area may be 15 W/cm² or higher, preferably 20 W/cm² or higher, and more preferably 25 W/cm² or higher although it cannot be generalized since it depends on a plasma generation apparatus, a constituent material or the like of a molded article. The upper limit of the output power per unit area may be, for example, 40 W/cm² or lower, but is not particularly limited. Further, in the case where pulsed output is used, pulse modulated frequency may be adjusted to 1 to 50 kHz (preferably 5 to 30 kHz) and pulse duty may be adjusted to 5 to 99% (preferably 15 to 80%, more preferably 25 to 70%). A cylindrical or plate-shaped metal piece with at least one side coated with a dielectric substance may be used as a counter electrode. The distance between mutually facing electrodes is preferably 5 mm or shorter, more preferably 3 mm or shorter, further preferably 1.2 mm or shorter, and particularly preferably 1 mm or shorter from a viewpoint of plasma generation and heating, although it depends on other conditions. The lower limit of the distance between mutually facing electrodes is not particularly limited, but may be, for example, 0.5 mm or longer.

A gas to be used for generating plasma may be, for example, rare gases such as helium, argon, and neon, and reactive gases such as oxygen, nitrogen, and hydrogen. That is, as a gas to be used in the present invention, it is preferable to use only a non-polymerizable gas. Further, among these gases, one or more kinds of rare gases alone may be used, and alternatively, a gas mixture containing one or more kinds of rare gases and a proper amount of one or more kinds of reactive gases may be used. Plasma generation may be carried out under conditions in which the above-mentioned gas atmosphere is controlled by using a chamber or under conditions completely open to the atmosphere in which the rare gases are made to flow to electrode parts.

Hereinafter, one example of the embodiment of an atmospheric-pressure plasma treatment applicable to the surface modification method of the present invention will be explained by mainly showing the case of using molded article in a sheet form (thickness: 0.2 mm) made of PTFE with referring to drawings, but the present invention should not be limited to these examples, and may be naturally carried out in various configurations without departing from the gist of the present invention.

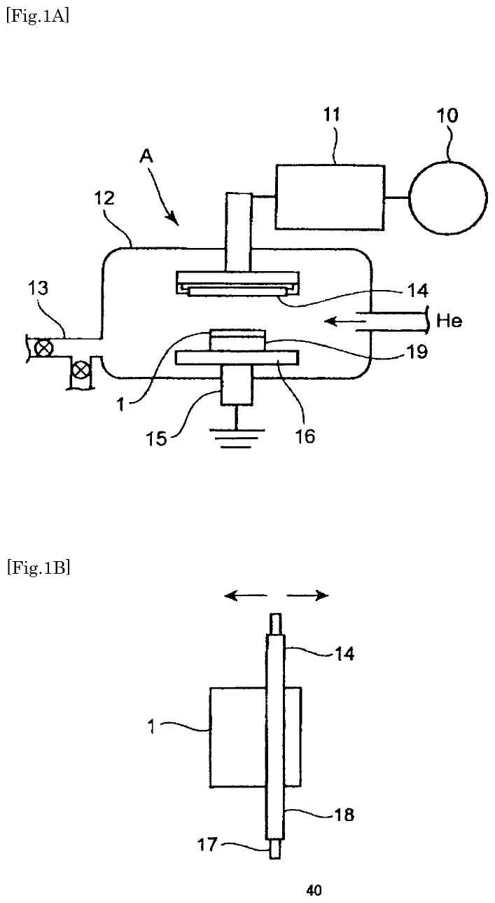

FIG. 1 shows a conceptual drawing of a capacitively coupled atmospheric-pressure plasma treatment apparatus which is one example of the atmospheric-pressure plasma treatment apparatus usable in the present invention. The atmospheric-pressure plasma treatment apparatus A shown in FIG. 1A includes a high frequency electric power source 10, a matching unit 11, a chamber 12, a vacuum exhaust system 13, an electrode 14, an earthed electrode elevating mechanism 15, a scanning stage 16, and a scanning stage control part (not illustrated). A sample holder 19 for holding a molded article 1 so that the molded article 1 opposes the electrode 14 is placed on the top surface of the scanning stage 16. As the sample holder 19, one made of, for example, an aluminum alloy can be employed. As the electrode 14, usable is one having a rod shape as illustrated in FIG. 1B and having a structure formed by sheathing the surface of an inner tube 17 made of, for example, copper with an outer tube 18 made of, for example, aluminum oxide (Al₂O₃).

The method for modifying the surface of a molded article 1 using the atmospheric-pressure plasma treatment apparatus A shown in FIG. 1 is as follows. First, the molded article 1 is washed with an organic solvent such as acetone or with water such as pure water if necessary, and then the molded article 1 in a sheet form is placed on the top surface of the sample holder 19 in the chamber 12 as shown in FIG. 1. Thereafter, air in the chamber 12 is sucked through the vacuum exhaust system 13 by a suction apparatus not illustrated to reduce the pressure and a gas for generating plasma is supplied to the chamber (see the arrow in FIG. 1A) to adjust the inside of the chamber 12 to be atmospheric pressure. The atmospheric pressure does not have to be strictly 1013 hPa, and may be in a range of 700 to 1300 hPa.

Next, the height of the electrode elevating unit 15 (the vertical direction in FIG. 1) is adjusted by the scanning stage control part to move the scanning stage 16 to a desired position. Adjustment of the height of the electrode elevating unit 15 enables adjustment of the distance between the electrode 14 and the surface (top surface) of the molded article 1. The distance between the electrode 14 and the surface of the molded article 1 is preferably 5 mm or shorter and more preferably 1.2 mm or shorter. Particularly, in the case where the temperature of the surface of a molded article 1 is controlled to be in a specific range by spontaneous temperature increase owing to a plasma treatment, the distance is particularly preferably 1.0 mm or shorter. To move the molded article 1 by the scanning stage 16, the distance between the electrode 14 and the surface of the molded article 1 should of course be longer than zero.

Further, plasma irradiation to a desired part of the surface of the molded article 1 is made possible by moving the scanning stage 16 in the direction at right angle to the axial direction of the electrode 14 (the direction of arrows in FIG. 1B (horizontal direction in FIG. 1)). For example, the moving rate of the scanning stage 16 is preferably 1 to 3 mm/s, but the present invention should not be limited to the example. In addition, the plasma irradiation time to the molded article 1 can be adjusted by, for example, adjusting the moving rate or reciprocating the scanning stage 16 a desired number of times.

The high frequency electric power source 10 is operated while the scanning stage 16 is moved to move the molded article 1, whereby plasma is generated between the electrode 14 and the sample holder 19, and thus a desired area of the surface of the molded article 1 is irradiated with plasma. In this case, for example, one having the frequency of applied voltage and output power density as described above may be used as the high frequency electric power source 10, and an electrode made of alumina-coated copper and a sample holder made of an aluminum alloy, for example, may be used to makes it possible to generate glow discharge under dielectric barrier discharge conditions. Accordingly, peroxide radicals can be produced stably in the surface of a molded article. Formation of dangling bonds is induced owing to defluorination in the PTFE sheet surface with radicals, electrons, ions and the like contained in the plasma, and the dangling bonds are reacted with oxygen and the like in the air by exposure to air remaining in the chamber or with clean air after the plasma treatment, thereby the peroxide radicals are introduced. Further, in the dangling bonds, hydrophilic functional groups such as hydroxy groups and carbonyl group are spontaneously formed besides peroxide radicals.

The intensity of plasma with which the surface of a molded article is irradiated may be properly adjusted by the above-mentioned various kinds of parameters of the high frequency electric power source, the distance between the electrode 14 and the surface of the molded article, and irradiation time. Consequently, in the case where the surface of a molded article is controlled to be in a specific range by spontaneous temperature increase by the plasma treatment, these conditions may be adjusted according to the characteristics of an organic polymer compound comprising the molded article. The above-mentioned preferable conditions (frequency of applied voltage, output power per unit area, pulse modulated frequency, pulse duty, and the like) for the atmospheric-pressure plasma generation are effective particularly in the case where the molded article is in form of a sheet made of PTFE. Further, it is possible to control the surface of a molded article within a specific temperature range by adjusting the integrated irradiation time to the surface of the molded article in accordance with the output power density. For example, the integrated irradiation time to the molded article surface is preferably 50 seconds to 3300 seconds, more preferably 250 seconds to 3300 seconds, and particularly preferably 550 seconds and 2400 seconds in the case where the frequency of the applied voltage is 5 to 30 MHz, the distance between the electrode 14 and the molded article surface is 0.5 to 2.0 mm, and the output power density is 15 to 30 W/cm². Particularly, it is preferable to adjust the surface temperature of a sheet-like molded article made of PTFE to 210 to 327° C. and to adjust irradiation time thereof to 600 to 1200 seconds. In the case where the irradiation time is long, the effect by heating tends to be produced. The plasma irradiation time means the integrated time of irradiation of the molded article surface with plasma, and it is sufficient that the molded article surface temperature is (melting point −120° C.) or higher at least partially during the plasma irradiation time. For example, it is sufficient that the molded article surface temperature is (melting point −120° C.) or higher over ½ or longer (preferably ⅔ or longer) of the plasma irradiation time. In any embodiment, adjustment of the surface temperature of a molded article to be within the above-mentioned range improves the mobility of PTFE molecules in the molded article surface, remarkably improves the probability of forming carbon-carbon bonds by bonding of carbon atoms of carbon-fluorine bonds in some PTFE molecules disconnected by plasma to carbon atoms of other PTFE molecules generated in the same manner, and improves the surface hardness. Further, although not illustrated, a heating means for heating the molded article 1 may be provided separately.

Further, the surface temperature of a molded article at the time of a plasma treatment may be measured by using, for example, a radiation thermometer or a temperature measurement seal (thermo-label).

The molded article 1 subjected to the atmospheric-pressure plasma treatment at a predetermined temperature in the above-mentioned manner is cooled to give a surface-modified molded article.

3. Step of Contact and Adhesion Between Surface-Modified PTFE and Unvulcanized Rubber Sheet

The above-described unvulcanized rubber sheet is brought into contact with the surface of the molded article modified through the above-mentioned procedure (modified surface), and the unvulcanized rubber sheet and the molded article are heated and subjected to pressure application, whereby polymers that are the base materials of the rubber can be cross-linked to harden the unvulcanized rubber, and the unvulcanized rubber sheet and the molded article can be directly joined to each other. Accordingly, a layered product of the vulcanized rubber and the surface-modified molded article formed from the fluorine-containing polymer compound is obtained. In a case where the rubber layer has a reactive functional group (derived from the crosslinking agent or the like), actions of the reactive functional group and peroxide radicals introduced into the surface of the surface-modified molded article are also considered to contribute to adhesion between the molded article and the rubber layer. The heating and pressure application treatment may be performed for about 10 to 40 minutes, with the heating temperature being, for example, 140 to 200° C. and with the pressure being, for example, 10 to 20 MPa. In a case where both the molded article and the rubber layer are each in the form of a sheet, they may be stacked and subjected to compression molding. In a case where the rubber layer is formed in a predetermined shape and the surface thereof is coated with the surface-modified molded article that is in the form of a sheet, for example, transfer molding may be performed in which the surface-modified molded article is disposed in the cavity of a mold in advance, and the rubber is injected into the cavity so as to form a rubber layer.

As described above in item “2.”, the surface of the fluorine-containing polymer compound layer is subjected to the plasma treatment. Therefore, in the layered product obtained through the above-described step of contact and adhesion, oxygen atoms are bonded to carbon atoms in a surface, of the fluorine-containing polymer compound layer, that faces the aforementioned rubber layer. The state where oxygen atoms are bonded to carbon atoms can be confirmed by performing chemical structural analysis through X-ray photoelectron spectroscopy (XPS).

The present application claims the benefit of priority to Japanese Patent Application No. 2017-108427 filed on May 31, 2017. The entire contents of the specifications of Japanese Patent Application No. 2017-108427 filed on May 31, 2017 are hereby incorporated by reference.

### EXAMPLES

Hereinafter, the present invention will be explained more concretely with reference to examples. The present invention should not be considered as being limited by the following examples, and, of course, modifications can be made appropriately without departing from the context mentioned above and below, and all of such modifications are within the technical scope of the present invention.

Tests of Putting SiO₂ Powder on Fluorine-Containing Polymer Compound Surface

A PTFE sheet (manufactured by NITTO DENKO CORPORATION, NITOFLON No. 900UL) having a predetermined shape and a thickness of 0.2 mm was subjected to ultrasonic cleansing in each of acetone and pure water, and nitrogen gas having a purity of 99% was jetted with an air gun to the PTFE sheet, thereby cleaning the surface of the PTFE sheet. A plurality of the PTFE sheets were prepared. Thereafter, surfaces of some of the surface-cleaned PTFE sheets were subjected to atmospheric-pressure plasma treatment with the above-described atmospheric-pressure plasma treatment apparatus under the following conditions, thereby preparing surface-modified PTFE sheets.

As the high frequency electric power source of the plasma generation apparatus, one having a frequency of applied voltage of 13.56 MHz was used. As the electrode, one having a structure formed by sheathing a copper tube having an inner diameter of 1.8 mm, an outer diameter of 3 mm, and a length of 165 mm with an alumina tube having an outer diameter of 5 mm, a thickness of 1 mm, and a length of 100 mm, was used. As the sample holder, one made of an aluminum alloy was used. Each molded article was placed on the sample holder, and the distance between the electrode and the surface of the molded article was set to 1.0 mm. A chamber was sealed and the pressure thereof was reduced to 10 Pa with a rotary pump, and then, helium gas was introduced into the chamber until the pressure reached the atmospheric pressure (1013 hPa). Thereafter, the high frequency electric power source was set such that the output power density became 18.6 W/cm² (output power: 65 W), and a scanning stage was set to move at a moving rate of 2 mm/s such that the scanning stage passed the electrode over the entire length in the longitudinal direction of the molded article (specifically, 30 mm). Thereafter, the high frequency electric power source was operated, the scanning stage was moved, and plasma irradiation was performed for a plasma-irradiation integrated time of 600 seconds. The total irradiation time was adjusted with the number of times of reciprocation of the scanning stage. The surface temperature of the molded article measured with a digital radiation temperature sensor (FT-H40K, FT-50A, or KZ-U3#, manufactured by KEYENCE CORPORATION) at the time of plasma treatment was 220° C.

Silica powder (manufactured by TOSOH CORPORATION, Nipseal VN3) was thinly spread on each PTFE sheet having only been cleaned but not having been subjected to atmospheric-pressure plasma treatment, and was overlaid with a PTFE sheet having been subjected to atmospheric-pressure plasma treatment, and heating and pressure application treatment was performed for 10 minutes at a temperature of 180° C. and a pressure of 10 MPa. Tests in each of which a PTFE sheet having only been cleaned but not having been subjected to atmospheric-pressure plasma treatment was used as the PTFE sheet overlaying the silica powder, were also conducted.

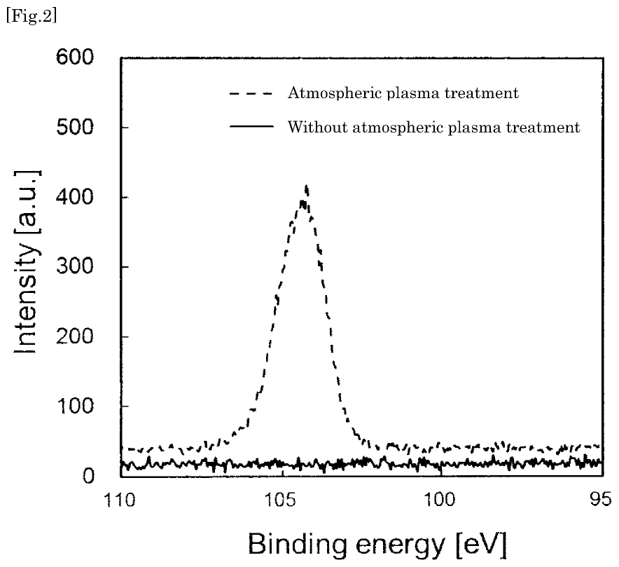

The surface of each PTFE sheet (product having been or not having been subjected to atmospheric-pressure plasma treatment) overlaying the silica powder was subjected several times to washing with distilled water and ultrasonic cleansing with distilled water and dried, and then XPS (X-ray Photoelectron Spectroscopy) analysis was performed. An Si2p spectrum obtained as a result of the XPS analysis is shown in FIG. 2.

According to FIG. 2, it can be confirmed that silica remains on the PTFE having been subjected to atmospheric-pressure plasma treatment.

Production of Layered Products

(Surface Modification of PTFE Sheets)

Each of PTFE sheets (manufactured by NITTO DENKO CORPORATION, NITOFLON No. 900UL) having been cut out so as to have a width of 45 mm×a length of 70 mm×a thickness of 0.2 mm, was subjected to ultrasonic cleansing in each of acetone and pure water, and nitrogen gas having a purity of 99% was jetted with the air gun to the PTFE sheet, thereby cleaning the surface of the PTFE sheet. Thereafter, a surface of each surface-cleaned PTFE sheet was subjected to atmospheric-pressure plasma treatment with the above-described atmospheric-pressure plasma treatment apparatus, thereby preparing a surface-modified PTFE sheet. The conditions of the atmospheric-pressure plasma treatment were the same as the conditions of the above-described tests of putting the SiO₂ powder.

(Production of Unvulcanized Rubber Sheets)

### Experimental Example 1

100 g of chlorinated butyl rubber (manufactured by JAPAN BUTYL Co. Ltd., CHLOROBUTYL 1066), 3 g of 2-di-n-butylamino-4,6-dimercapto-s-triazine (manufactured by SANKYO KASEI Co., Ltd., ZISNET (registered trademark)) as a crosslinking agent, 3 g of paraffin-based oil (manufactured by Idemitsu Kosan Co., Ltd., Diana Process Oil PW380) as a plasticizer, 1 g of magnesium oxide (manufactured by Kyowa Chemical Industry Co., Ltd., Kyowamag 150 (registered trademark)) as an acid acceptor, and 0 g to 30 g of silica powder (manufactured by TOSOH CORPORATION, Nipseal VN3), were kneaded to produce an unvulcanized rubber sheet having a thickness of 2 mm with use of a rubber roll machine (manufactured by Nippon Roll MFG. Co., Ltd., a mixing roll machine (φ 200 mm×L 500 mm)), and portions each having a size of 30 mm×30 mm were cut out of the unvulcanized rubber sheet.

### Experimental Example 2

100 g of natural rubber (type: ribbed smoked sheet, grade: RSS3), 3.5 g of sulfur (manufactured by Hosoi Chemical Industry. Co., Ltd., Fine Powder Sulfur 5) as a crosslinking agent, 0.7 g of N-(tert-butyl)-2-benzothiazole sulfenamide (manufactured by SANSHIN CHEMICAL INDUSTRY CO., LTD., SANCELER NS-G) as a vulcanization accelerator, 0.5 g of stearic acid (manufactured by New Japan Chemical Co., Ltd.) and 6 g of zinc oxide as crosslinking activators, and 0 g to 30 g of silica powder (manufactured by TOSOH CORPORATION, Nipseal VN3), were kneaded to produce an unvulcanized rubber sheet having a thickness of 2 mm with use of the rubber roll machine (manufactured by Nippon Roll MFG. Co., Ltd., a mixing roll machine (φ 200 mm×L 500 mm)), and portions each having a size of 30 mm×30 mm were cut out of the unvulcanized rubber sheet.

### Experimental Example 3

100 g of natural rubber (type: ribbed smoked sheet, grade: R553), 3.75 g of PERCUMYL (registered trademark) D40 (manufactured by NOF CORPORATION, dicumyl peroxide (purity: 40%)) as a crosslinking agent, and 25 g of silica powder (manufactured by TOSOH CORPORATION, Nipseal VN3) or 25 g of cellulose powder (manufactured by FUJIFILM Wako Pure Chemical Corporation, 400-mesh), were kneaded to produce an unvulcanized rubber sheet having a thickness of 2 mm with use of the rubber roll machine (manufactured by Nippon Roll MFG. Co., Ltd., a mixing roll machine (φ 200 mm×L 500 mm)), and portions each having a size of 30 mm×30 mm were cut out of the unvulcanized rubber sheet.

### Experimental Example 4

100 g of natural rubber (type: ribbed smoked sheet, grade: R553), 3.5 g of sulfur (manufactured by Hosoi Chemical Industry. Co., Ltd., Fine Powder Sulfur 5) as a crosslinking agent, 0.7 g of N-(tert-butyl)-2-benzothiazole sulfenamide (manufactured by SANSHIN CHEMICAL INDUSTRY CO., LTD., SANCELER NS-G) as a vulcanization accelerator, 0.5 g of stearic acid (manufactured by New Japan Chemical Co., Ltd.) and 6 g of zinc oxide as crosslinking activators, and 30 g of silica powder (manufactured by TOSOH CORPORATION, Nipseal VN3) or 30 g of titanium oxide powder (manufactured by FUJIFILM Wako Pure Chemical Corporation, rutile type), were kneaded to produce an unvulcanized rubber sheet having a thickness of 2 mm with use of the rubber roll machine (manufactured by Nippon Roll MFG. Co., Ltd., a mixing roll machine (φ200 mm×L 500 mm)), and portions each having a size of 30 mm×30 mm were cut out of the unvulcanized rubber sheet. An unvulcanized rubber sheet in which 3 g of 2-di-n-butylamino-4,6-dimercapto-s-triazine had been further added to the above-described composition, was also produced.

Each of the unvulcanized rubber sheets produced in Experimental Examples 1 to 4 was brought into contact with one of the above-described surface-modified PTFE sheets, and both sheets were subjected to heating and pressure application treatment for 10 minutes at a temperature of 180° C. and a pressure of 10 MPa such that a joined range had a size of 20 mm×30 mm and a non-joined range (holding-margin) had a size of 10 mm×30 mm, thereby producing a layered product of the PTFE sheet and the rubber sheet (vulcanized rubber sheet).

Using a precision universal tester (manufactured by Shimadzu Corporation, AUTOGRAPH AG-1000D), T-shaped peeling tests were conducted in which the holding-margin was held between chucks, and the PTFE sheet and the vulcanized rubber sheet were pulled in directions that are different from each other by 180°, thereby measuring the adhesive strength between the PTFE sheet and the rubber sheet. A 1-kN load cell was used, and the pull rate was 10 mm/min. The results of the tests are indicated in Table 1. Each value indicated in Table 1 is a maximum value obtained during a test period.

TABLE 1

| | | Composition in rubber | | | | | | |
|---|---|---|---|---|---|---|---|---|
| | | Polymer as the | | | | | | Adhesive |
| | | base material | | | | | | strength |
| | | of the rubber | Crosslinking agent | SiO₂ | Cellulose | TiO₂ | Other | (N/mm) |
| Experimental | 1 | Chlorinated | 2-di-n-butylamino-4,6- | — | — | — | Magnesium oxide 1 g | 0.04 |
| Example 1 | 2 | butyl rubber | dimercapto-s-triazine | 10 g | — | — | Paraffin-based oil plasticizer 3 g | 0.17 |
| | 3 | 100 g | 3 g | 20 g | — | — | | 0.23 |
| | 4 | | | 30 g | — | — | | 0.83 |
| Experimental | 1 | Natural rubber | Sulfur | — | — | — | Zinc oxide 1 g | 0.04 |
| Example 2 | 2 | 100 g | 3.5 g | 10 g | — | — | Vulcanization accelerator 0.7 g | 0.16 |
| | 3 | | | 20 g | — | — | Stearic acid 0.5 g | 0.36 |
| | 4 | | | 30 g | — | — | | 1.8 |
| Experimental | 1 | Natural rubber | PERCUMYL D40 | — | 25 g | — | — | 0.14 |
| Example 3 | 2 | 100 g | 3.75 g | 25 g | — | — | | 0.35 |
| Experimental | 1 | Natural rubber | Sulfur 3.5 g | 30 g | — | — | Zinc oxide 6 g | 1.8 |
| Example 4 | 2 | 100 g | Sulfur 3.5 g | — | — | 30 g | Vulcanization accelerator 0.7 g | 0.06 |
| | 3 | | 2-di-n-butylamino-4,6- | 30 g | — | — | Stearic acid 0.5 g | 1.2 |
| | 4 | | dimercapto-s-triazine 3 g | — | — | 30 g | | 0.00 |

According to Table 1, it has been found that, in the case where the rubber layer contains SiO₂, favorable adhesiveness is obtained as compared to the case where no SiO₂ is contained (Experimental Examples 1-2, 1-3, and 1-4, Experimental Examples 2-2, 2-3, and 2-4, Experimental Example 3-2, and Experimental Examples 4-1 and 4-3). Although Experimental Example 3-1 contains cellulose and Experimental Examples 4-2 and 4-4 contain TiO₂, none of these Experimental Examples exhibit an effect of improving the adhesive strength as prominently as the Experimental Examples containing SiO₂ do.

### INDUSTRIAL APPLICABILITY

The layered product according to the present invention can be formed by directly adhering the fluorine-containing polymer compound and the rubber composition to each other without using any adhesive, and thus is suitably applicable to the medical care-, biology-, and food-related fields in which contamination with adhesives needs to be prevented.

### DESCRIPTION OF THE NUMERALS

10 high frequency electric power source
11 matching unit
12 chamber
13 vacuum exhaust system
14 electrode
15 electrode elevating mechanism
16 scanning stage
17 inner tube
18 outer tube
19 sample holder
A atmospheric-pressure plasma treatment apparatus

1-7. (canceled)

8. A layered product in which a fluorine-containing polymer compound layer and a rubber layer formed from a rubber composition are stacked, wherein
a surface roughness Ra of the fluorine-containing polymer compound layer is 1 μm or lower,
the fluorine-containing polymer compound is polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit,
an amount of an organic peroxide contained per 100 parts by mass of the rubber composition is smaller than 0.1 parts by mass,
the rubber layer contains SiO₂ and a rubber base material, and
a proportion of SiO₂ per 100 parts by mass of the rubber layer is 30 parts by mass or higher.

9. The layered product according to claim 8, wherein
the rubber composition is a natural rubber composition and/or a butyl-based rubber.

10. The layered product according to claim 8, wherein
an adhesive strength between the fluorine-containing polymer compound layer and the rubber layer is 0.15 N/mm or greater.

11. The layered product according to claim 8, wherein
the adhesive strength between the fluorine-containing polymer compound layer and the rubber layer is greater than a strength of the rubber layer.

12. The layered product according to claim 8, wherein
oxygen atoms are bonded to carbon atoms in a surface, of the fluorine-containing polymer compound layer, that faces the rubber layer.

13. A method for producing a layered product in which a fluorine-containing polymer compound layer and a rubber layer are stacked,
the fluorine-containing polymer compound being polytetrafluoroethylene or a copolymer of a difluoromethylene unit and at least one of a hexafluoropropylene unit, a perfluoroalkyl vinyl ether unit, a methylene unit, an ethylene unit, and a perfluorodioxole unit,
the method comprising the steps of:
producing an unvulcanized rubber sheet from a natural rubber composition that contains SiO₂,
causing a temperature of a surface of a molded article formed from the fluorine-containing polymer compound to be (a melting point of the polymer compound −120° C.) or higher and subjecting the surface of the molded article to atmospheric-pressure plasma treatment, to produce a surface-modified molded article, and
bringing the modified surface of the surface-modified molded article and the unvulcanized rubber sheet into contact with each other, and heating and applying pressure to the surface-modified molded article and the unvulcanized rubber sheet.
